(19) United States
(12) Patent Application Publication
(10) Pub. No.: US 2009/0157748 A1
(43) Pub. Date: Jun. 18, 2009

(54) SYSTEMS AND METHODS FOR SEEKABLE LAYER FILE ENCODING AND DECODING

(75) Inventor: John M. Hess, Alpharetta, GA (US)

Correspondence Address: SUTHERLAND ASBILL & BRENNAN LLP, 999 PEACHTREE STREET, N.E., ATLANTA, GA, 30309, US

(73) Assignee: MCKESSON FINANCIAL HOLDING LIMITED, Hamilton (BM)

(21) Appl. No.: 11/957,171

(22) Filed: Dec. 14, 2007

(51) Int. Cl. G06F 7/00

(52) U.S. Cl. 707/104.1; 707/E17.009

(57) ABSTRACT

The present invention provides for efficient random access to the contents of files encoded with two or more layers of standard or custom encoding. In accordance with an embodiment of the present invention, a file of transaction messages are encoded by dividing the file into multiple discretely-sized, blocks of data are independently encoded. When information in a certain transaction message within the unencoded file is requested, only the encoded block(s) containing that transaction message is decoded.

### FIELD OF THE INVENTION

The present invention generally relates to efficiently searching data files with multi-layer encoding.

### BACKGROUND OF THE INVENTION

The processing of prescription claims is a highly automated process. Retail pharmacies fulfill hundreds of millions of prescriptions annually, most of which result in prescription claims that are processed electronically. These prescription claims are electronically transmitted from the retail pharmacy to a claims switch, which then directs the prescription claim to the appropriate payor such as an insurance company. These prescription claims are processed and stored in near-real time, thereby expediting the process of clearing and fulfilling the prescription at the retail pharmacy.

Oftentimes the processing of a prescription claim involves multiple electronic messages being sent between the pharmacy and payor through the claims switch. These messages may be designed to conform to a data structure defined by The National Counsel for Prescription Drug Programs (NCPDP), which is an ASNI-accredited standards development organization for data transfer to and from the pharmacy services sector of the healthcare industry. Hundreds of millions of these NCPDP transaction messages are transmitted annually between pharmacies and payors, wherein each message may include any number of data elements defined by the NCPDP standard. These messages are typically collected into files and archived by the claims switch for a variety of reasons, such as audits, customer troubleshooting, data mining and reporting.

Because of the nature of the information stored in these NCPDP transaction messages collected over time, analytical tools have been developed to mine this data for a variety of purposes, such as customer troubleshooting, data mining, and reporting. However, due to the vast amount of this data that has accumulated over time even the most simple searches may take a prohibitive amount of time. This problem is exacerbated by the fact that the volume of data necessitates that the NCPDP transaction messages be compressed to save memory space, and because of the nature of the information contained in the NCPDP transaction messages, the Health Insurance Portability and Accountability Act (HIPAA) requires that these messages also be encrypted to protect the privacy of the consumer's personal information. This results in hundreds of millions of compressed and encrypted files containing these NCPDP transaction messages for which there is no commercially available search tool that provides rapid random access to transaction level information contained in these encoded (i.e., compressed and encrypted) files.

There exists certain file search tools such as ISAM that provide for the searching of single-layer encoded flat file records. However, such search tools are not designed to work on files that include data such as NCPDP transaction messages that have nested record structures. In particular, the NCPDP messages include numerous segments or groupings of elements, and within those segments there are further elements, some of which can repeat. Therefore sometimes a NCPDP message may include repeating information within repeating information, thereby preventing search tools such as ISAM from providing reliable results.

A reduction in search time may be achieved by creating an index of the locations within each file where certain predetermined data elements of the NCPDP transaction messages in each file may be found. Accordingly, when searching the files of a NCPDP transaction messages the index can be utilized to identify which file(s) contain the relevant NCPDP transaction messages so only those files are decoded, rather than decoding every file in search of the messages containing the relevant data. However, in order to retrieve the data from a file once the file has been located, the complete file still has to be decoded and then its contents parsed to retrieve the desired NCPDP transaction message. This is a time consuming task requiring extensive processing overhead, especially considering the number of files that might need to be decoded in connection with any given search.

Therefore, a need exists for systems and methods that provide rapid random access to content within multi-layer encoding files.

### SUMMARY OF INVENTION

The present invention provides for efficient random access to the contents of files encoded with one or more layers of standard or custom encoding. In accordance with an embodiment of the present invention, a file of transaction messages are encoded by dividing the file into multiple discretely-sized blocks of data that are independently encoded. When information in a certain transaction message within the file is requested, only the encoded block(s) containing that transaction message is decoded. This reduces the amount of disk I/O and CPU cycles necessary to retrieve the requested information.

### BRIEF DESCRIPTION OF THE DRAWING(S)

Reference will now be made to the company drawings, which were not necessarily drawn to scale, and wherein;

FIG. 1 illustrates a schematic diagram of an exemplary claim processing system in accordance with an embodiment present invention.

FIG. 2 illustrates an exemplary data structure of a transaction message stored by a claims switch in accordance with an embodiment of the present invention.

FIG. 3 illustrates an exemplary data structure of a data file comprising transaction messages in accordance within the embodiment present invention.

FIG. 4 illustrates an exemplary data structure of an encoded file in accordance within an embodiment of the present invention.

FIG. 5 illustrates a schematic diagram of the relationship between a transaction message, a data file, and an encoded file in accordance within an embodiment of the present invention.

FIG. 6 illustrates a process flowchart of an exemplary method for encoding a data file in accordance within an embodiment of the present invention.

FIG. 7 illustrates a process flowchart of an exemplary method for retrieving an transaction message from an encoded file in accordance with an embodiment of the present invention.

### DETAILED DESCRIPTION OF EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention are described below with reference to block diagrams and flowchart illustrations of systems, methods, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing the functions specified in the flowchart block or blocks.

Accordingly, blocks of the block diagrams and flowchart illustrations may support combinations of means for performing the specified functions, combinations of elements or steps for performing the specified functions, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions, elements or steps, or combinations of special purpose hardware and computer instructions.

Exemplary embodiments of the present invention will hereafter be described with reference to the figures, in which like reference symbols indicate like elements throughout the several drawings. For illustrative purposes, the present invention is described below in the context of the processing of prescription claim transactions, though it will be appreciated by one of ordinary skill when that the present invention has broad application to, file systems comprising sensitive data with multiple layers of encoding that needs to be searched in a fast and efficient manner. In particular, when a data file has multiple layers of encoding, such as standard or customized compression and encryption, such as in order to protect sensitive data contained therein, the present invention can be utilized to encode those files in a manner that facilitates the rapid random access to information located at arbitrary positions within the encoded file utilizing the decoding technique of the present invention, essentially emulating a native operating system seeks in function and performance. Accordingly, the present invention should not be limited to the embodiment described below.

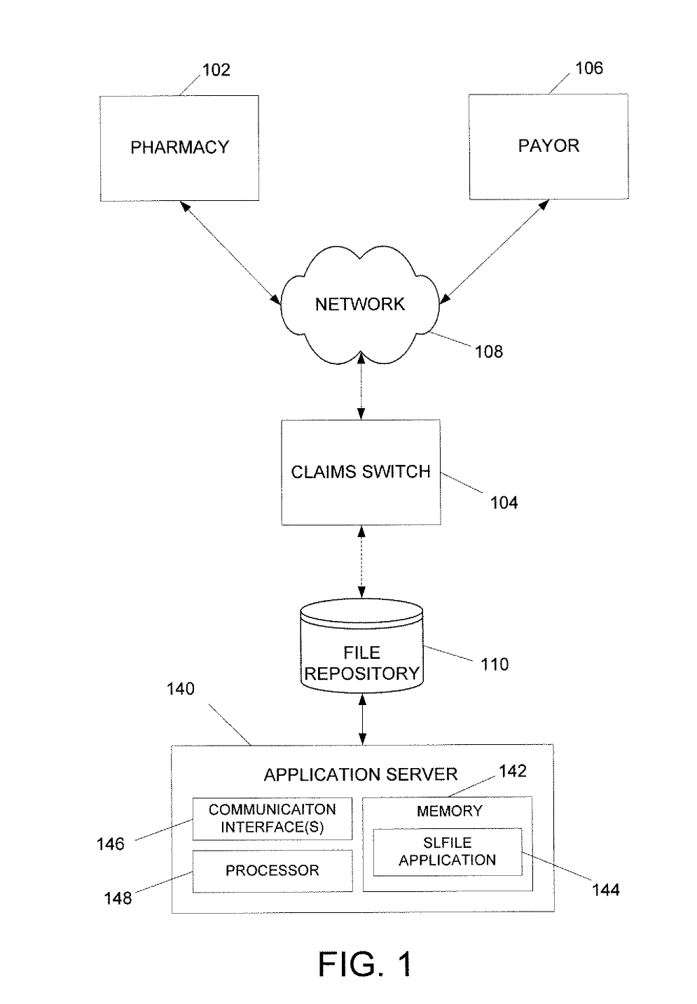

FIG. 1 shows a block diagram of a prescription claim processing system according to an illustrative embodiment of the present invention. In particular, FIG. 1 is an exemplary operating environment for the implementation of certain embodiments of the present invention, and includes a pharmacy 102, a claims switch 104, and a payor 106, which are each configured for accessing and reading associated computer-readable media having stored their own data and/or computer-executable instructions for implementing the various methods of the present invention. Generally, network devices and systems including hardware and/or software for transmitting and receiving data and/or computer-executable instructions over a communications link and a memory for storing data and/or computer-executable instructions. Network devices and systems may also include a processor for processing data and executing computer-executable instructions, as well as other internal and peripheral components that are well known in the art. As used herein, the term “computer-readable media” describes any form of memory or a propagated signal transmission medium. Propagated signals representing data and computer-executable instructions are transferred between the network devices and systems disclosed.

As shown in FIG. 1, the pharmacy 102 may be in communication with a claims switch 104 via a network 108. The network 108 may comprise any telecommunication and/or data network, whether public or private, such as a local area network, a wide area network, an intranet, an internet and/or any combination thereof and may be wired and/or wireless. Due to network connectivity, various methodologies as described herein may be practiced in the context of distributed computing environments.

The pharmacy 102 may be configured for receiving prescription claim data, creating prescription transactions therefrom and transmitting the prescription transactions to the claims switch 104. Prescription claim data includes any data that is typically provided by a patient, pharmacists and/or other healthcare provider in relation to filling a prescription and/or requesting approval or authorization for payment from a payor or claim adjudicator, as may be requited by an applicable standard protocol. A payor may be an insurance company, a financial institution, a pharmacy benefit manager (PBM) or a financial service provider. Prescription claim data may be inputted to the pharmacy 102 by a pharmacist or other healthcare provider or may be received by the pharmacy 102 in electronic form from an electronic prescription service (not shown). The pharmacy 102 also may be configured for handling other types of prescription transactions.

Prescription claim transactions are electronic records or messages intended to facilitate the communication of prescription information. For example, prescription claim transactions are intended to communicate prescription claim data between pharmacies and payors. The content and format of a prescription claim may vary depending on the standard protocol used. For example, a widely used protocol in prescription claim transactions is the NCPDP standard for messaging between the pharmacy and payor. In general, prescription claim transactions will identify at least the intended payor recipient, the drug product to be dispensed, for example, by national drug code number (“NDC #”), the quantity to be dispensed whether the prescription relates to a new prescription or a refill prescription, and billing-related information. However, it should be understood that various systems and methods of the invention may be practiced in connection with other types of data and data processing systems requiring rapid random access to information in files having multiple layers of encoding.

Prescription claim transactions may be transmitted from the pharmacy 102 to the claims switch 104 in batch, real-time or near real-time. Pharmacies may connect to the claims switch 104 through a variety of methods, including dial-up, frame relay or leased-line. The entire system is preferably supported by redundant software, communication links, and uninterrupted power supplies, and thereby ensuring that all connections will provide reliable, continuous operation. The system also preferably insures that all the provider-submitted claim transactions are routed quickly, accurately, and consistently. The claim processing system eliminates provider postage and handling expenses by allowing pharmacies (or other healthcare entities) to submit claims to payors 106 electronically, thereby substantially reducing the cost of submitting claims and speeding up the providers payment cycles.

In certain embodiments, the claims switch 104 may serve as a clearinghouse for multiple payors 106. As noted above, the payor 106 may include systems operated by insurance companies, financial institutions, PBMs, and other financial service providers. In its capacity as a clearinghouse, the claims switch 104 is operable to parse prescription claim transactions and forward them to the appropriate payor 106 for processing. Approval, authorization or rejection messages may be returned to claims switch 104 from the payor 106 and such messages may be forwarded by the claims switch 104 to the appropriate pharmacy 102, all of which may be in accordance with a standard protocol, such as NCPDP.

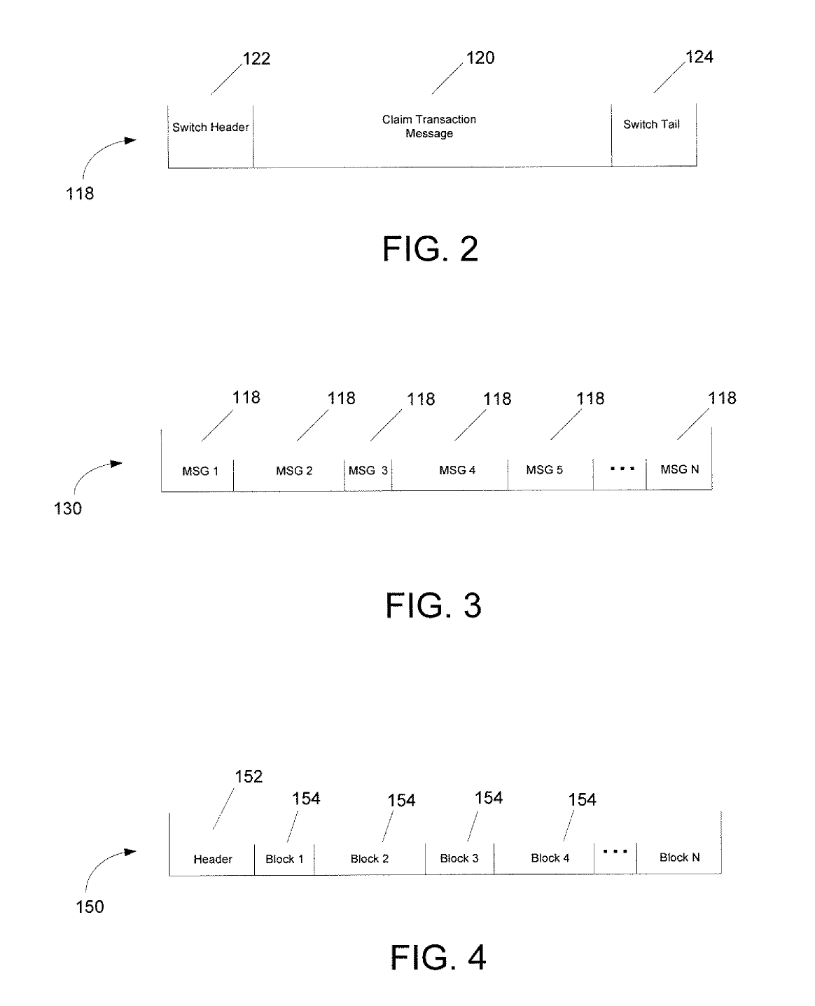

Serving as a clearinghouse, the claims switch 104 may be configured to archive copies of the claim transaction messages sent between the pharmacy 102 and payor 106 for future reference, such as in creating an audit log. These pharmacy transaction claim messages may be stored as a switch message 118 in the data structure illustrated in FIG. 2, where the raw data of the claim transaction message 120 is combined with a switch header 122 and a switch tail 124. In accordance with NCPDP standards, the claim transaction message is a nested record structure which prevents it from being efficiently searched by a commercially available file format search tools. The switch header 122 and the switch tail 124 provide operational data from the claims switch 104. For example, the switch header 122 may include the time of the message, the telecommunication line of which the message was received, and other information related to the handling of the message by the claims switch 104. The switch tail 124 may likewise comprise information concerning communications originating with the payor 106. The size of the switch message 118 may vary according to the nature of the claim transaction message, though typically the messages are between 300-3,000 bytes.

A plurality of the switch message 118 collected at the claims switch 104 may be combined and stored in a data file 130, as illustrated in FIG. 3. The switch messages 118 stored in the data file 130 may vary in length depending on the nature and complexity of the claim transaction messaging between the pharmacy 102 and the payor 106. Accordingly, throughout each day as prescription claims are being processed by the claims switch 104, the corresponding switch messages 118 are collected in data files 130. By way of example, a single data file 130 may include up to or in excess of 1000 switch messages 118. The data files 130 may be stored in a file repository 110, as illustrated in FIG. 1.

In accordance with an aspect of the present invention, an application server 140 is in communication with the file repository 110, and includes in a memory 142, an SLFile application 144, a communications interface(s) 146, and a processor 148. Although the server application 140 is shown for simplicity as being in communication with only the file repository 110, it is to be understood that any other network configuration is possible and that any illustrative device may be a communication with any other illustrative device or other devices not illustrated. For example, the server application 140 may be in direct communication with the claims switch 104.

The application server 140 may be any processor-driven device. The memory 142 may store data files and various program modules, such as an operating system, in addition to the SLFile application 144. The SLFile application 144 may comprise computer executable instructions for performing various routines, such as those for encoding, verifying and decoding the data files 130 in accordance with the present invention. The communications interface 146 may facilitate communication between the application server 140 and various I/O devices, such as a keyboard, mouse, printer, microphone, speaker, monitor, etc, as well as facilitate communications between the application server 140 and other external devices such as the file repository 110. Those skilled in the art will appreciate that the application server 140 may include alternate and/or additional components, hardware or software. In addition, the application server 140 may be connected to a local or wide area network (not shown) that may include other devices, such as routers, firewalls, gateways, etc.

In accordance with the present invention, the SLFile application 144 may include several software modules that may be configured to individually or collectively perform various encoding, decoding and verification processes, as discussed herein. For example, the SLFile application 144 may be configured to perform multi-layered coding on the plurality of data files 130 in the file repository 110 to generate an encoded data file 150, as illustrated in FIG. 4. For purposes of describing the illustrative embodiment, the terms encoding and decoding generally refer to the process of transforming data from one format into another, such as through standard or custom compression or encryption techniques.

The encoded data file 150 may comprise a header 152 and a plurality of data blocks 154. Each data block 154 is generated by encoding a fixed-sized data segment from a data file 130. The header 152 of the encoded data file 150 comprises information relating to the encoded data file 150, such as the size of each data block 154, the type of encoding, the fixed-sized data segment size used to generate each data block 154, the unencoded size of the last data block 154, a CRC checksum value for data file 130, etc. Due to the nature of various encoding techniques, and in particular the compression algorithm utilized the size of each data block 154 may vary.

The contents of the encoded data file 150 can be verified by initially generating a first checksum value on the original unencoded data file 130. Next, the encoded data file 150 can be decoded and a second checksum value generated. The first and second checksum values can be compared to verify the contents of the encoded data file 150.

The SLFile application 144 also may be configured to perform the decoding of an encoded data file in order to retrieve specific transaction information located in a claim transaction message 120 within an encoded data file 150. This may be performed utilizing a seek-and-read methodology whereby only the data block(s) 154 containing the specified claim transaction message 120 is decoded (e.g., decrypted and decompressed) rather than decoding the entire encoded data file 150, thereby limiting the number of CPU cycles required to retrieve the requested transaction information.

In order to identify the specific data block(s) 154 to decode in response to a request for certain transaction information, the original data file 130 may be indexed on predetermined data elements in the switch messages 118. Such data elements, as may be required by the applicable standards protocol, such as NCPDP, may include the pharmacy ID, drug ID, bin number, prescriber, etc. Utilizing this index, the SLFile application 144 may identify the switch message(s) 118 containing the requested transaction information, and from that determine the associated data file(s) 130, and from that the associated encoded data file(s) 150.

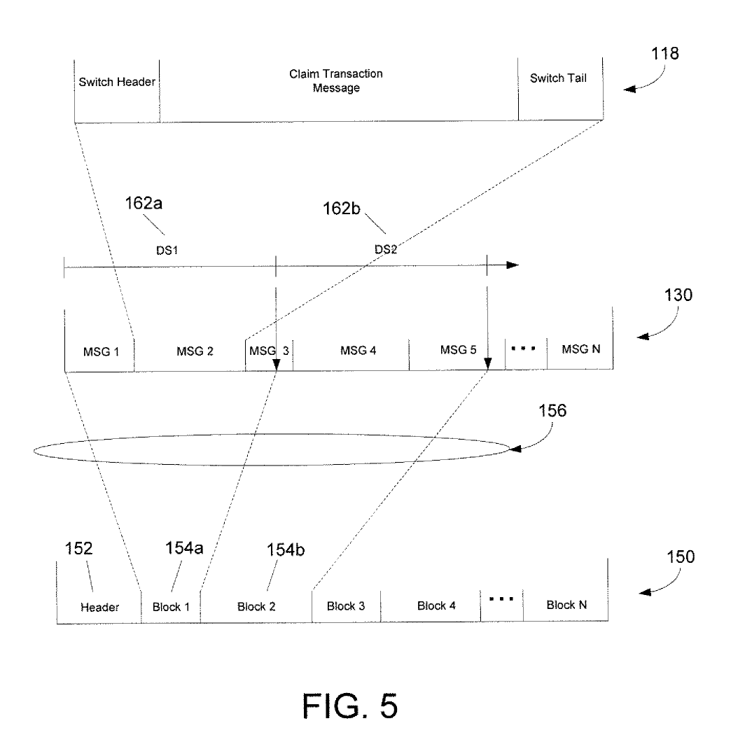

With reference to FIG. 5 the relationships between the switch message 118, the data file 130 and the encoded data file 150 are illustrated schematically. As shown, a single switch message 118 may be combined with other switch messages 118 to form an unencoded data file 130. The unencoded data file 130 may be indexed on predetermined data elements, and the indexed information stored in a location accessible by SLFile application 144, such as in file repository 110. In the illustrated embodiment where the encoding process 156 may comprise compression and encryption, a first fixed-size data segment 162a, referenced as DS1, is taken from the original unencoded data file 130 and then encoded (e.g., compressed and encrypted) generate to a first data block 154a, referenced as Block 1. Subsequently, a second fixed-sized data segment 162b, referenced as DS2 of the same size as the first fixed-sized data segment 162a is taken from the original unencoded data file 130 and then encoded to generate a second data block 154b, referenced as Block 2. This process continues with the encoding of fixed-sized data segments taken from the data file 130 until all the data in the data file 130 has been encoded.

While the data segment size is fixed in the illustrative embodiment, it will be appreciated that the data segment size may be configured, but in any case the size of the data segments will be included in the header 152 of the encoded data file 150. The fixed size of the data segment may be configured to balance the desired efficiencies in the operation of SLFile application 144. For instance, the larger the data segment the less efficient the SLFile application will be in searching the encoded data file 150 as larger amounts of data will need to be decoded in order to retrieve the requested information. Alternatively, the smaller the data segments then the compression efficiency will be less, requiring more disk space.

When searching for certain transaction information stored within various transaction claim messages 120 within various switch messages 118, an initial search is made of the file-based indexes to identify the specific switch message(s) 118 that contain the desired transaction information. In the illustrated embodiment, the index search provides the name(s) of the encoded data file(s) 150 containing the desired transaction information which may be identified based on the switch messages 118 and data file 130 where the information resides, and the byte location(s) within unencoded data file 130 where the switch message 118 containing the desired transaction information begins. By simply dividing the byte location in the unencoded data file 130 by the configured data segment size, which is fixed and stored in header 152, and then rounding up to the next whole integer the data block 154 containing the requested information can be identified. For example, if the fixed byte location in unencoded data file 130 is 5,000 and the fixed data segment size is 4,000 bytes, then the second data block 154 in the encoded data file 150 would include the desired information (5,000÷4,000=1.2, rounded up to 2).

In the above example, the SLFile application 144 will retrieve only the second data block 154 from the encoded data file 150 and decode, e.g., decrypt and decompress, that data block. This takes substantially less time than decoding the entire encoded data file 150 in order to retrieve the switch message 118 beginning at byte location 5000. Once the second block has been decoded, knowing that the data in the second data block begins as 4001, the SLFile application 144 begins reading data at byte position 1,000 in the decoded data block 154. The SLFile application 144 reads a predetermined number of bytes of data beginning at that location While the predetermined number of bytes read may be configurable by the user, it may be desirable to have the byte number equal to or slightly larger than the typical maximum switch message size. If the predetermined number of bytes read by the SLFile application 144 is more than the remaining bytes in the unencoded data block 154, then the next subsequent data block, that is, Block 3 in the present example, may be decoded and the predetermined number of bytes read from the beginning of that unencoded data from data block 3 to ensure the complete switch message 118 beginning at unencoded byte location 5000 is retrieved. The requested information may then be extracted from the retrieved switch message 118, and the requested transaction information can be returned to the user or other applications for further processing.

Those skilled in the art will appreciate that the operating environment shown and described with respect to FIG. 1 is provided by way of example only. Numerous other operating environments, system architectures and device configurations are possible. For example, the invention may be implemented in a non-network environment, in which a standalone application server 140 executes the SLFile application 144 on a locally stored file system data. Accordingly, the present invention should not be construed as being limited to any particular operating environments, system architectures, or device configuration.

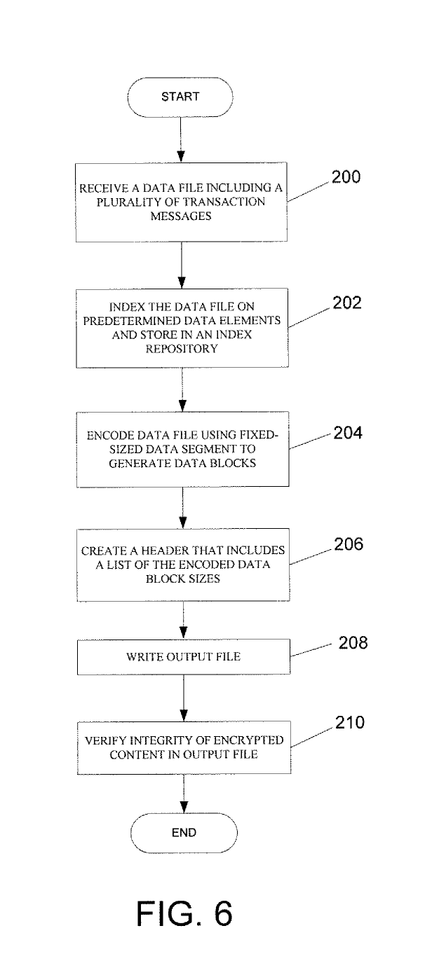

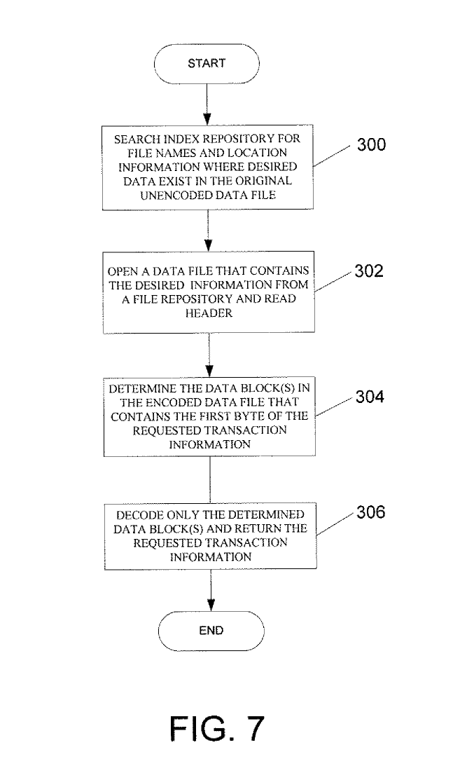

The invention will be better understood with regards to an illustrative example, the basic process of which is illustrated in the flowcharts provided in FIGS. 6 and 7. With reference to FIG. 6, an illustrative example of the encoding performed by the SLFile application 144 is provided. As indicated by block 200, a data file is received, wherein the data file which includes a plurality of transaction messages. The data file is then indexed on predetermined data elements and the index information is stored in an index repository for future searching, as indicated by block 202. The data file is then encoded using fixed-sized data segments to generate encoded data blocks, as indicated by block 204. According to the present invention any number of layers of standard or custom encoding may be utilized in the course of the present invention, and in the illustrative embodiment the encoding comprises compression and encryption. At block 206, a header is created that includes a list of the encoded data block sizes and other information such as the type of encoding, the data segment size utilized in the encoding, the decoded size of the last data block, and a CRC checksum value. The header may then be combined with the data blocks to comprise an encoded data file that can be written to an output file, as indicated by block 208. As an optional step, as illustrated in block 210, the encoded data file 150 can have the integrity of its encrypted content verified by decrypting the encoded data file 150 and comparing the decoded information to a stored checksum value. This checksum value which is stored in the header 152 of the encoded data file 150, is generated from the unencrypted data file 130 prior to the encoding step of block 204. Accordingly, if a checksum value generated from the decoded data file matches the checksum value from the original unencoded data file 130, then the contents of the encoded data file 150 are verified.

In accordance with the present invention, rapid random searching of the transaction information stored in the encoded data files 150 for the millions of pharmacy claim transactions conducted by claims switch 104 can be facilitated by initially searching the index(es) for identification of the encoded data file(s) 150 and the unencrypted data file location of the switch messages 118 that include the requested transaction information. With the file names and byte location the switch message 118 in the unencoded data file 130, the specific encoded data file(s) 150 can be retrieved from the file repository 110 in the decoding process performed thereon.

With reference to FIG. 7, at block 300 the index repository is searched for the file names and location information where the desired transaction information exists in the original unencoded data file 130. The SLFile application 144 then opens a first data file 130 that contains the desired transaction information and reads the header 152, as indicated by block 302. Knowing the byte location in unencoded data file 130, the SLFile application 144 can determine which block or blocks of the encoded data file 1500 to decode, as indicated by block 304. Only the encoded data block or blocks determined to include the requested transaction information are decoded in order to reduce the amount of processing necessary to retrieve that data from the encoded data file 150. The requested transaction information can then be retrieved from the unencoded data block or blocks, as indicated by block 306.

Many modifications and other embodiments of the inventions set forth herein will come to mind to one skilled in the art to which these inventions pertain, having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for retrieving encoded transaction information associated with a pharmacy transaction, comprising:
receiving a request for the transaction information;
searching an index of data elements associated with pharmacy transaction messages in a plurality of data files to identify at least a first data file including the requested transaction information and at least one location of the transaction information within the first data file;
opening a first data file, wherein the data file includes a header and a plurality of data blocks of encoded pharmacy transaction messages;
reading the header and determining a first data block in the first data file that contains the first byte of the requested transaction information;
decoding at least the first data block and outputting the transaction information; and
generating a report based at least in part on the transaction information, and presenting the report to a user.

2. The method of claim 1, wherein the step of decoding includes decoding a second data block if the transaction information is not wholly contained within the first data block.

3. The method of claim 1, wherein the step of decoding includes decrypting and decompressing the first data block.

4. The method of claim 1 wherein the transaction information comprises a data element in a pharmacy transaction message generated at least in part by a pharmacy.

5. The method of claim 1, wherein the first data file is a nested record structure file format.

6. The method of claim 1, wherein the step of reading the header includes reading the sizes of the data blocks in the first data file.

7. The method of claim 1, wherein the step of reading the header includes reading at least one of the sizes of the data blocks in the first data file, a type of encoding, or a data segment size utilized to encode the first data file into data blocks.

8. The method of claim 1, wherein the at least one location of the transaction information within the first data file comprises a position in the unencoded first data file, and wherein the step of determining a first data block in the first data file that contains the first byte of the requested transaction information includes determining the first data block based at least in part on the position in the unencoded first data file and a data segment size utilized to encode the first data file into data blocks.

9. A method for storing transaction information associated with a pharmacy transaction in a HIPAA compliant data file, comprising:
receiving a HIPAA compliant data file including a plurality of transaction messages;
indexing in an index repository the data file on predetermined data elements associated with transaction messages;
encoding the data file utilizing fixed-sized data segments of the data file to generate a plurality of encoded data blocks;
generating a header that includes size indicators for the encoded data blocks;
generating an encoded data file comprising the header and the encoded data blocks; and
storing in memory the encoded data file.

10. The method of claim 11, where in the step of encoding includes compressing and encrypting the data file.

11. The method of claim 11, further including storing the index repository.

12. The method of claim 11, further including verifying the contents of the encoded data file.

13. The method of claim 12, further comprising generating a first checksum value for the data encoded into the encoded first data file, and wherein verifying the contents of the encoded data file includes comparing the first checksum value to a second checksum value associated with a decoded version of the encoded data file.

14. The method of claim 11, wherein generating a header comprises generating a header that includes the size indicator for each encoded data block generated, a type of encoding, or a data segment size utilized to encode the first data file into data blocks.

15. A system for retrieving encoded transaction information associated with a pharmacy transaction, comprising:
a memory comprising a plurality of encoded data files, the encoded data filed including pharmacy transaction messages, and an index repository of indexed data elements associated with the pharmacy transaction messages in a plurality of data files; and
a processor in communication with the memory, wherein the processor is configured to:
receive a request for the transaction information;
search the index repository to identify at least a first data file including the requested transaction information and at least one location of the transaction information within the first data file;
open a first data file, wherein the first data file includes a header and a plurality of data blocks of encoded pharmacy transaction messages;
read the header and determine a first data block in the first data file that contains the first byte of the requested transaction information; and
decode at least the first data block and output the transaction information.

16. The system of claim 16, wherein the processor is further configured to generate a report based at least in part on the transaction information.

17. The system of claim 16, wherein the processor is further configured to decode a second data block if the transaction information is not wholly contained within the first data block.

18. The system of claim 16, wherein the processor decodes the first data block by decrypting and decompressing the first data block.

19. The system of claim 16, wherein the header read by the processor includes sizes of the data blocks in the first data file.

20. The system of claim 16, wherein the at least one location of the transaction information within the first data file comprises a position in the unencoded first data file, and the first data block in the encoded first data file that contains the first byte of the requested transaction information is determined based at least in part on the position in the unencoded first data file and a data segment size utilized to encode the first data file into a plurality of data blocks.
